(19) United States
(12) Patent Application Publication
(10) Pub. No.: US 2026/0237912 A1
(43) Pub. Date: Aug. 13, 2026

(54) ANTENNA UNIT, ANTENNA DEVICE, AND COMMUNICATION BASE STATION

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Yiqun Hu, Beijing (CN); Feng Qu, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 19/153,669

(22) PCT Filed: Jun. 14, 2024
(86) PCT No.: PCT/CN2024/099418

§ 371 Date: Aug. 5, 2025

(30) Foreign Application Priority Data
Jul. 27, 2023 (CN) 202310937026.8

(51) Int. Cl. H01Q 15/16; H01Q 1/24; H01Q 1/36; H01Q 1/42; H01Q 1/50; H01Q 19/10

(52) U.S. Cl. CPC H01Q 15/16; H01Q 1/246; H01Q 1/36; H01Q 1/42; H01Q 1/50; H01Q 19/10

(57) ABSTRACT

An antenna unit is used for being arranged in a cylindrical shell, at least one side wall of the cylindrical shell is in a shape of an are; and the antenna unit includes: a coaxial cable conductor, a feed structure and two radiating substrates; the coaxial cable conductor includes an inner conductor and an outer conductor sleeved outside the inner conductor, the inner conductor is connected to an end of the feed structure, another end of the feed structure is coupled to one of the two radiating substrates, and the other one of the two radiating substrates is connected to the outer conductor; and the antenna unit is provided with at least one bending section, to conform to the cylindrical shell through the at least one bending section.

This application claims the priority of the Chinese Patent application filed on Jul. 27, 2023 before the CNIPA, China National Intellectual Property Administration with the application number of 202310937026.8, and the title of “ANTENNA UNIT, ANTENNA DEVICE, AND COMMUNICATION BASE STATION”, which is incorporated herein in its entirety by reference.

### TECHNICAL FIELD

The present disclosure relates to the technical field of communication and more particularly, to an antenna unit, an antenna device and a communication base station.

### BACKGROUND

In the field of mobile communication, antennas are generally used for signal transmission and reception. With the development of communication technology, broadband and miniaturization are basic principles of antenna design. For the antenna used in mobile communication, it generally need to be conformal with the installation environment, which means that the shape and size of the antenna need to be adapted to the installation environment. In this way, when designing such antennas, it is necessary to consider that the antenna can still maintain the expected antenna performance while conforming to the installation environment.

### SUMMARY

The present disclosure provides an antenna unit, an antenna device and a communication base station.

In a first aspect, the present disclosure provides an antenna unit, the antenna unit is used for being arranged in a cylindrical shell, at least one side wall of the cylindrical shell is in a shape of an arc; and the antenna unit includes: a coaxial cable conductor, a feed structure and two radiating substrates;
the coaxial cable conductor includes an inner conductor and an outer conductor sleeved outside the inner conductor, the inner conductor is connected to an end of the feed structure, another end of the feed structure is coupled to one of the two radiating substrates, and the other one of the two radiating substrates is connected to the outer conductor; and
the antenna unit is provided with at least one bending section, to conform to the cylindrical shell through the at least one bending section.

In an optional embodiment, at least one of the two radiating substrates is provided with a first bending section at an edge close to the side wall that is in the shape of the arc, the first bending section has an angle with a plane of the radiating substrates, and the angle is adapted to curvature of the are.

In an optional embodiment, the angle is an obtuse angle.

In an optional embodiment, the coaxial cable conductor is perpendicular to a radiating surface of the radiating substrate, and a size of an orthographic projection of the first bending section on a first plane is less than a size of an orthographic projection of the radiating substrate on the first plane;
wherein the first plane is a plane perpendicular to the coaxial cable conductor.

In an optional embodiment, the feed structure includes a first feeder line and a plurality of second feeder lines;
one end of the first feeder line is connected to the inner conductor, and the other end of the first feeder line is connected to the plurality of second feeder lines;
wherein the plurality of second feeder lines are coupled to the radiating substrate coupled to the feed structure, and the plurality of second feeder lines extend along different directions of the radiating substrate.

In an optional embodiment, an angle of every two second feeder lines is less than or equal to 90 degrees.

In an optional embodiment, the plurality of second feeder lines include feeder lines extending along two adjacent sides of the radiating substrate.

In an optional embodiment, the plurality of second feeder lines include two third feeder lines extending along two adjacent sides of the radiating substrate and a fourth feeder line between the two third feeder lines;
wherein a line width of the fourth feeder line is greater than a line width of the third feeder line; and/or, a length of the fourth feeder line is greater than a length of the third feeder line.

In an optional embodiment, each of the two radiating substrates includes a hollow area and a solid material area surrounding the hollow area;
wherein the feed structure is coupled to the solid material area.

In an optional embodiment, a shape of the hollow area includes at least one of a polygon, a circle, a sector, an ellipse, and an irregular shape.

In an optional embodiment, the solid material area includes a plurality of path areas that are interconnected, and the plurality of path areas form a current path through which current passes;
wherein the plurality of path areas include at least a target path area extending into the hollow area.

In an optional embodiment, the target path area includes a first stub area and a second stub area interconnected to the first stub area;
a size of the second stub area in a target direction is greater than a size of the first stub area in the target direction, the target direction is a direction perpendicular to a direction of current flowing through the target path area;
wherein the first stub area is located between the feed structure and the second stub area.

In an optional embodiment, the second stub area is provided with a notch at an end away from the feed structure.

In an optional embodiment, the feed structure includes a feeder line coupled to a partial area of the target path area away from the hollow area.

In an optional embodiment, the antenna unit further includes a reflective plate, the reflective plate is connected to an end of the coaxial cable conductor away from the radiating substrate;
the reflective plate is provided with a second bending section at an edge close to the side wall that is in the shape of the arc, the first bending section is oriented towards the second bending section, and the second bending section is oriented towards the first bending section; and
an orthographic projection of the second bending section on a second plane does not overlap with an orthographic projection of the first bending section on the second plane, wherein the second plane is a plane parallel to the coaxial cable conductor.

In an optional embodiment, an orthographic projection of the reflective plate on a first plane covers orthographic projections of the two radiating substrates on the first plane; the first plane is perpendicular to the second plane;
a first orthographic projection of the first bending section on the first plane is located at a side of a second orthographic projection of the second bending section on the first plane that is close to the radiating substrates;
wherein the first orthographic projection does not overlap with or partially overlaps with the second orthographic projection.

In an optional embodiment, the antenna unit further includes a resonant structure corresponding to a dipole, the resonant structure is used for increasing a resonance point of the antenna unit;
the resonant structure is arranged at a side of the radiating substrate away from the feed structure, and an orthographic projection of the resonant structure on a first plane overlaps with an orthographic projection of the radiating substrate on the first plane; wherein the first plane is parallel to a radiating surface of the radiating substrate.

In an optional embodiment, when the antenna unit includes two orthogonal dipoles, the resonant structure includes a circular ring:
or, the resonant structure includes a plurality of circular arcs that are spaced, different circular arcs correspond to different radiating substrates, and the plurality of circular arcs correspond to a same center point of a circle.

In a second aspect, the present disclosure provides an antenna device, including the cylindrical shell and the plurality of antenna units described above, wherein the plurality of antenna units are arranged at intervals in the cylindrical shell, and the antenna device further includes;
a feed network, connected to the coaxial cable conductor of each of the plurality of antenna units, to feed electrical signals into the coaxial cable conductor and feed the electrical signals into the feed structure through the coaxial cable conductor.

In a third aspect, the present disclosure provides a communication base station, including the antenna unit described above, or including the antenna device described above.

Using the antenna unit provided in the present disclosure, the antenna unit may be used for being arranged in the cylindrical housing, at least one side wall of the cylindrical shell is in the shape of the arc. Specifically, the antenna unit includes the coaxial cable conductor, the feed structure, and two radiating substrates. Among them, the coaxial cable conductor includes the inner conductor and the outer conductor sleeved outside the inner conductor. One end of the feed structure is connected to the inner conductor, the other end of the feed structure is coupled to one of the two radiating substrates, the other one of the two radiating substrates is connected to the outer conductor. The antenna unit is provided with at least one bending section to conform to the cylindrical shell through the bending section. Since the antenna unit is provided with at least one bending section to conform to the cylindrical shell, the antenna unit is adapted to the arc shape of the cylindrical shell through the bending section. Therefore, the antenna unit does not interfere with the cylindrical shell through bending, achieving good conformity between the antenna unit and the cylindrical shell. This allows the entire antenna to conform to the installation environment while still maintaining the expected antenna performance. Additionally, by designing the first bending section, performance indicators such as antenna radiation pattern gain and a bandwidth can be adjusted.

In addition, since the antenna unit has at least one bending section, the antenna can achieve a miniaturized design while maintaining the expected natural performance. As a result, it can be matched with a smaller cylindrical shell, thereby reducing the space occupation of the installation environment.

The above description is only an overview of the technical solution of the present disclosure. In order to have a clearer understanding of the technical means of the present disclosure, it can be implemented according to the content of the specification. In order to make the above and other purposes, features, and advantages of the present disclosure more obvious and understandable, the specific implementation methods of the present disclosure are listed below.

### BRIEF DESCRIPTION OF THE DRAWINGS

In order to more clearly illustrate the technical solution of the embodiments of the present disclosure, a brief introduction will be given to the accompanying drawings required to be used in the embodiments and related art. It is obvious that the accompanying drawings described below are only some embodiments of the present disclosure. For those skilled in the art, other drawings may be obtained based on these drawings without creative work. It should be noted that the scale in the accompanying drawings is only for illustration and does not represent the actual scale.

FIG. 1 shows a schematic diagram of cross-sectional shapes of several cylindrical shells according to an embodiment of the present disclosure;

FIG. 2 shows a top-view plan diagram of an antenna unit according to an embodiment of the present disclosure;

FIG. 3 shows a perspective view of an antenna unit in a cylindrical shell according to an embodiment of the present disclosure;

FIG. 4 shows a top-view plan diagram of four radiating substrates of an antenna unit according to an embodiment of the present disclosure;

FIG. 5 shows a top-view plan diagram of another antenna unit according to an embodiment of the present disclosure;

FIG. 6a shows a top-view plan diagram of an antenna unit when a resonant structure is a circular ring according to an embodiment of the present disclosure;

FIG. 6b shows a top-view plan diagram of an antenna unit when a resonant structure is a circular arc according to an embodiment of the present disclosure;

FIG. 7 shows a top-view plan diagram of another antenna unit according to an embodiment of the present disclosure;

FIG. 8 shows a top-view plan diagram of another antenna unit according to an embodiment of the present disclosure;

FIG. 9a shows a top-view plan diagram of an antenna substrate according to an embodiment of the present disclosure;

FIG. 9b shows a top-view plan diagram of another antenna substrate according to an embodiment of the present disclosure;

FIG. 10 shows a top-view plan diagram of another antenna substrate according to an embodiment of the present disclosure;

FIG. 11 shows a Smith chart of an exemplary antenna unit according to an embodiment of the present disclosure;

FIG. 12 shows a waveform diagram of a S parameter of an antenna unit according to an embodiment of the present disclosure;

FIG. 13 shows a schematic diagram of a cross-sectional structure of an antenna device in an axial direction of a cylindrical shell according to an embodiment of the present disclosure;

FIG. 14 shows a schematic diagram of a feed network according to an embodiment of the present disclosure;

FIG. 15 shows a S-parameter diagram when 8 antenna units are arranged in an array inside the cylindrical shell according to an embodiment of the present disclosure; and

FIG. 16 shows a directional diagram when 8 antenna units are arranged in an array inside the cylindrical shell according to an embodiment of the present disclosure.

### REFERENCE NUMERAL

100, cylindrical shell; 200, antenna unit; 300, reflective plate; 400, resonant structure; 500, feed network; 101, side wall in the shape of an arc; 102, horizontal side wall; 201, coaxial cable conductor; 2011, inner conductor; 2012, outer conductor; 202, feed structure; 2021, first feeder line; 2022, second feeder line; 203, radiating substrate; 204, first bending section; 301, second bending section; 401, circular ring; 2031, hollow area; 2032, solid material area; 205, target path area; 2051, first stub area; 2052, second stub area; 2023, fifth feeder line; 501, first connecting line; 502, second connecting line; 503, total feed port.

### DETAILED DESCRIPTION

In order to clarify the purpose, technical solution, and advantages of the embodiment of the present disclosure, a clear and complete description of the technical solution of the embodiment of the present disclosure will be provided below in conjunction with the accompanying drawings. Obviously, the described embodiments are a part of the embodiments of the present disclosure, not all of the embodiments. Based on the embodiments of the present disclosure, all other embodiments obtained by persons skilled in the art without creative work are within the scope of protection of the present disclosure.

In related art, when designing mobile communication base stations, in order to save space and alleviate the tight base station site resources while reducing costs (space cost, raw material cost of the antenna, and leasing cost of the base station site), it is necessary to miniaturize the communication base station, which requires the antenna used in the communication base station to also be miniaturized. On the other hand, in order not to damage the appearance of the installation environment, the shape of the antenna of the communication base station needs to be conformal with the installation environment. In conformal design, a cylindrical shell is generally used to cover the antenna. However, in this way, the antenna will interfere with the cylindrical shell, affecting the antenna effect.

In view of this, it is necessary to design antennas with wide bandwidth, miniaturization, and good compatibility with the installation environment. To achieve this goal, the present disclosure provides an antenna unit that may have at least one bending section, so that the antenna unit can conform to the cylindrical casing through the bending section, thereby preventing interference between the antenna unit and the cylindrical casing (cylindrical shell), achieving good conformity and miniaturization design. Specifically, in the case where the antenna unit adopts a dipole antenna, the bending section can be arranged at an edge of a radiating arm (radiating substrate) of the dipole close to the cylindrical shell.

Among them, the cylindrical shell mentioned in the present disclosure can be a shell in a cylindrical shape or an elliptical shape, or a shell with an arc-shaped side wall, such as a semi-circular shell. Referring to FIG. 1, it shows a schematic diagram of cross-sectional shapes of several cylindrical shells. As shown in FIG. 1, for the cylindrical shells A and B, the cylindrical shell A is elliptical-shaped and the cylindrical shell B is cylindrical-shaped, both cylindrical shells A and B have side walls 101 in the shape of a circular arc around them.

Among them, as shown in FIG. 1, for the cylindrical shell C and the cylindrical shell D, they include side walls 101 in the shape of arc and horizontal side walls, that is, the side walls without curvature. The two opposite first side walls 102 in the cylindrical shell C are the horizontal side walls, and the other two opposite second side walls 101 are arc-shaped. The cross-sectional shape of the cylindrical shell D is semi-circular, with one side wall 102 being horizontal and the remaining side walls 101 being arc-shaped.

Among them, the side walls of the cylindrical shell that are arc-shaped have the curvature that may be concave towards the inside of the shell or convex towards the outside of the shell. As shown in FIG. 1, the arc-shaped side walls of the cylindrical shell A to the cylindrical shell D have the curvature that is convex towards the outside of the shell.

The design of the arc-shaped side wall can be understood as the external design required to achieve conformity with the installation environment when deploying the communication base station.

Certainly, the cylindrical shell may not be limited to the shapes shown in FIG. 1. In some examples, the entire side wall of the cylindrical shell may be arc-shaped, while in other examples, the arc-shaped side wall may only be a partial area on one surface of the cylindrical shell. That is to say, not the entire side wall is arc-shaped, but a partial area in the side wall is arc-shaped. In some other examples, the cylindrical shell may be a cylinder with an irregularly shape, not limited to the shapes shown in FIG. 1.

Among them, regardless of the shape of the cylindrical shell, as long as at least one bending section that matches the arc is designed in the antenna unit, it can make the antenna unit adapt to the cylindrical shell and reduce interference between the antenna unit and the cylindrical shell.

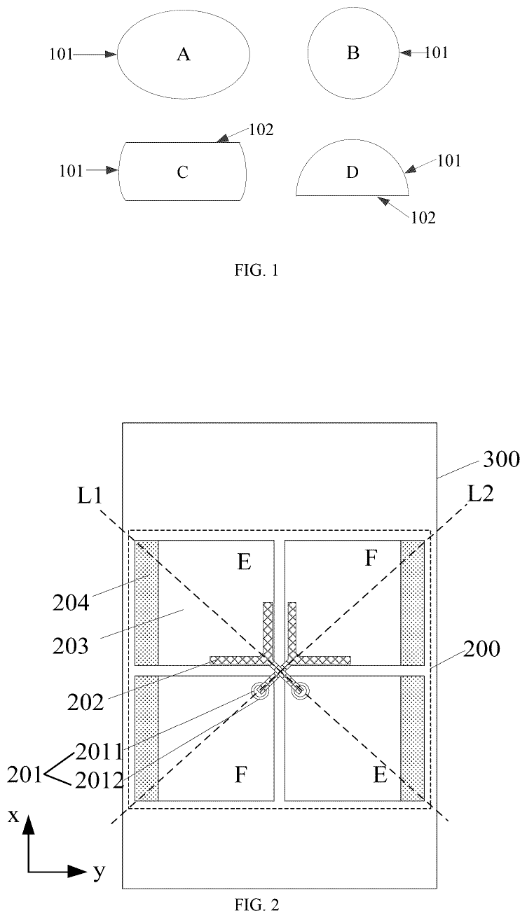

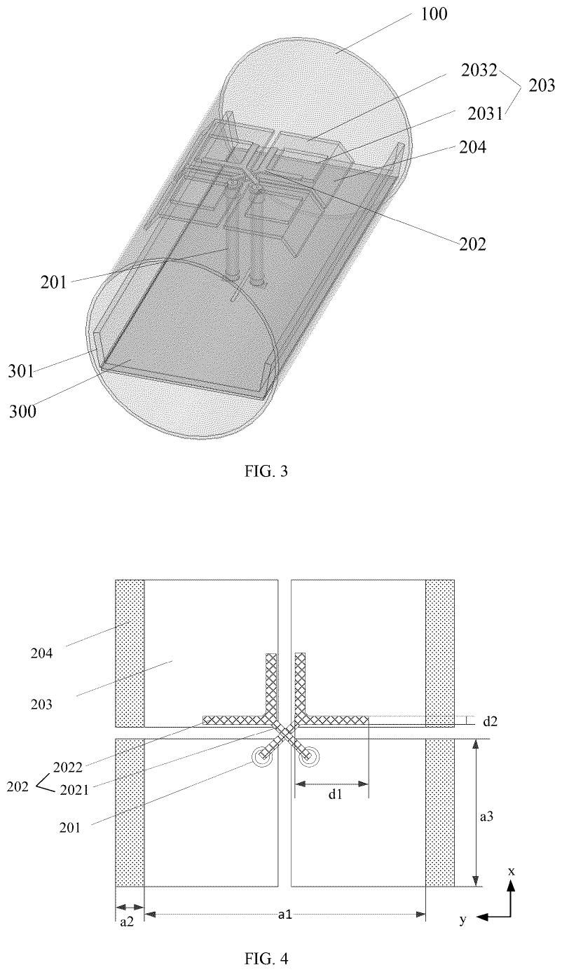

Referring to FIG. 2, FIG. 3 and FIG. 4, FIG. 2 shows a top-view plan diagram of an antenna unit according to an embodiment of the present disclosure; FIG. 3 shows a perspective view of an antenna unit in a cylindrical shell according to an embodiment of the present disclosure; FIG. 4 shows a top-view plan diagram of four radiating substrates of an antenna unit according to an embodiment of the present disclosure. As shown in FIG. 2 to FIG. 4, the antenna unit 200 of the present disclosure may be arranged in a cylindrical shell 100, at least one side wall of the cylindrical shell 100 is in a shape of an arc, specifically, several cylindrical shells 100 as shown in FIG. 1. The antenna unit 200 may include: a coaxial cable conductor 201, a feed structure 202 and two radiating substrates 203.

The coaxial cable conductor 201 includes an inner conductor 2011 and an outer conductor 2012 sleeved outside the inner conductor 2011, the inner conductor 2011 is connected to an end of the feed structure 202, another end of the feed structure 202 is coupled to one of the two radiating substrates 203, and the other one of the two radiating substrates 203 is connected to the outer conductor 2012.

The antenna unit is provided with at least one bending section, to conform to the cylindrical shell through the at least one bending section.

Specifically, the coaxial cable conductor 201, the feed structure 202, and the two radiating substrates 203 in the antenna unit of the present disclosure can form a radiating group, and the antenna unit can include multiple such radiating groups, such as including two radiating groups, and the two radiating groups can be orthogonal. In one example, the coaxial cable conductor 201, the feed structure 202, and the two radiating substrates 203 can form a dipole, the two radiating groups form two dipoles, and the two dipoles can be orthogonal.

Specifically, at least one bending section of the antenna unit can be arranged at the radiating substrate 203 or on other components of the antenna unit, such as the outer conductor 2012, specifically, as long as it is conformal with the cylindrical shell and does not interfere with each other. For example, at least one bending section can be arranged on the radiating substrate 203, and more specifically, as shown in FIG. 3, it can be arranged on the edge of the radiating substrate 203 close to the cylindrical shell.

Among them, when the bending section is arranged on the radiating substrate 203, it can be arranged on the edge close to the arc-shaped side wall of the cylindrical shell, or on the edge of the radiating substrate 203 close to the non-arc-shaped side wall of the cylindrical shell.

In one example, the coaxial cable conductor 201, the feed structure 202, and the two radiating substrates 203 can form one dipole, and the antenna unit 200 can include one dipole or two dipoles, the two dipoles form a pair of dipoles of the antenna unit 200. In the case of including the two dipoles, the two dipoles are orthogonal, as shown in FIG. 2, including the dipole E and the dipole F, where the dipole E and the dipole F both include two radiating substrates 203, a total of four radiating substrates 203. Each dipole includes one feed structure 202. The two radiating substrates 203 of the dipole E are located on a line L1, and the two radiating substrates 203 of the dipole F are located on a line L2. The line L1 and line L2 are orthogonal, and the feed structure 202 of the dipole E is also orthogonal to the feed structure 202 of the dipole F. Therefore, the antenna unit 200 includes two orthogonal dipoles. When the two dipoles intersect, the intersecting dipoles generate a new resonant mode in the frequency band, expanding the bandwidth of the antenna.

For each dipole, it includes the coaxial cable conductor 201, the feed structure 202, and the two radiating substrates 203. Specifically, the coaxial cable conductor 201 includes an inner conductor 2011 and an outer conductor 2012 sleeved outside the inner conductor 2011. The inner conductor and the outer conductors 2012 can be made of the same metal material, or certainly, made of different metal materials.

Among them, the inner conductor 2011 is connected to one end of the feed structure 202, thereby feeding current into the feed structure 202, while the other end of the feed structure 202 is connected to another radiating substrate 203 of the dipole, and the outer conductor 2012 is connected to one radiating substrate 203 of the dipole. For the dipole E, the dipole E includes the coaxial cable conductor 201, the feed structure 202, and the two radiating substrates 203. The outer conductor 2012 of the coaxial cable conductor 201 of the dipole E is connected to one of the two radiating substrates 203, the inner conductor 2011 is connected to one end of the feed structure 202, and the other end of the feed structure 202 is connected to the other radiating substrate 203, so as to feed the current into the two radiating substrates 203 through the coaxial cable conductor 201 and the feed structure 202, thereby enabling the dipole to enter the working state.

Among them, the feed structure 202 is coupled to the radiating substrate 203, the coupling can refer to overlap used to feed the current introduced by the inner conductor 2011 into the radiating substrate 203. In one example, the feed structure 202 can be a feeder line, with one end connected to the inner conductor 2011 and the other end coupled to the radiating substrate 203. In another example, one end of the feed structure 202 coupled to the radiating substrate 203 may have multiple coupling branches, as shown in FIG. 2 and FIG. 3. Different coupling branches can be coupled to different areas of the radiating substrate 203. Certainly, the feed structure 202 is not limited to the above shape. Among them, in the case where there are two dipoles and the two dipoles are orthogonal, the feed structures 202 of the two dipoles are also orthogonal, and the shapes of the two feed structures 202 can be symmetrical.

In one example, the feed structure 202 overlaps with a partial area of the radiating substrate 203, that is, the feed structure 202 is coupled to the partial area of the radiating substrate 203. Therefore, the orthographic projection of the feed substrate on the radiating substrate 203 is covered by the radiating substrate 203. Specifically, as shown in FIG. 4, in one example, the length d1 of the part where the feed structure 202 couples with the radiating substrate 203 can be 12 mm, and the width d2 of the part where the feed structure 202 couples with the radiating substrate 203 can be 2 mm.

Using the antenna unit 200 of this embodiment, due to the antenna unit having at least one bending section, the antenna can achieve a miniaturized design while maintaining the expected antenna performance. As a result, it can be matched with a smaller cylindrical shell 100, thereby reducing the space occupation of the installation environment.

In one example of the present disclosure, since the cylindrical shell 100 has at least one side wall in the shape of the arc, in order to achieve good conformity with the cylindrical shell 100 when the antenna unit 200 is located inside the cylindrical shell 100, the radiating substrate 203 of each dipole can have a first bending section 204 at the edge close to the arc-shaped side wall 101. Specifically, according to the arc-shaped side wall 101 of the cylindrical shell 100, at least one radiating substrate 203 in the antenna unit 200 may have the first bending section 204.

Among them, when the cylindrical shell 100 is a shell 100 in a cylindrical shape and in an elliptical shape, each radiating substrate 203 in the antenna unit 200 may have the first bending section 204, such as including four radiating substrates 203, each of the four radiating substrates 203 has the first bending section 204.

Among them, when the cylindrical shell 100 is a semi-circular shell, as shown in D in FIG. 1, according to the placement position of the antenna unit 200, each radiating substrate 203 in the antenna unit 200 can also have the first bending section 204, or only one radiating substrate 203 of each dipole in the antenna unit 200 has the first bending section 204, and the radiating substrates 203 having the first bending sections 204 in the two dipoles can be located on the same side. For example, the radiating substrate 203 on one side close to the arc-shaped side wall 101 of the cylindrical shell 100D has the first bending section 204, while the radiating substrate 203 on one side close to the horizontal side wall 102 of the cylindrical shell 100D does not have the first bending section 204.

Certainly, for the cylindrical shell 100 in an irregularly shape, or the cylindrical shell 100 with only a partial area of the side wall being arc-shaped, it is only necessary to set that the radiating substrate 203 on the side close to the arc-shaped side wall 101 has the first bending section 204 at its edge.

Certainly, in another example, in order to enhance the signal transmission capability of the antenna unit 200, regardless of whether the cylindrical housing 100 is a regular shape, each radiating substrate 203 may have the first bending section 204, and a symmetrical pattern may be formed between the first bending sections 204 of multiple radiating substrates 203.

Specifically, in one example, the edge of the radiating substrate 203 close to the arc-shaped side wall 101 can be bent towards the side away from the radiating surface of the radiating substrate 203, thereby forming the first bending section 204. Among them, the radiating surface of the radiating substrate 203 can be understood as the emission surface of the radiating substrate 203 that emits signals outward.

Certainly, in another example, the edge of the radiating substrate 203 close to the arc-shaped side wall 101 can also be bent towards one side of the radiating surface of the radiating substrate 203, thereby forming the first bending section 204. Regardless of the bending method used to form the first bending section 204, it can be used to reduce interference between the antenna unit 200 and the cylindrical shell 100, thereby achieving the goal of conforming to the cylindrical shell 100.

Specifically, due to the arc-shaped side walls on the cylindrical shell 100 having concave side walls towards the inside of the shell and convex side walls towards the outside of the shell, as shown in FIG. 1, both are the convex side walls towards the outside of the shell. In the case where the arc-shaped side wall is the concave side wall towards the inside of the shell, the first bending section 204 can also adapt to the arc-shaped side wall and bend along the concave curvature. In this case, the orthographic projection of the end of the first bending section 204 away from the radiating substrate 203 on the radiating surface can overlap with the radiating substrate 203. That is to say, the first bending section 204 can be folded on the radiating surface of the radiating substrate 203 or on the surface of the radiating substrate 203 away from the radiating surface. Certainly, this bending method still needs to avoid the interference with the cylindrical shell 100.

In the case where the arc-shaped side wall is the convex side wall towards the outside of the shell, the first bending section 204 can be bent along the convex curvature. In this case, the orthographic projection of the end of the first bending section 204 away from the radiating substrate 203 on the radiating surface does not overlap with the radiating substrate 203, as shown in FIG. 3. The first bending section 204 can be bent towards the cylindrical shell 100 without folding on the radiating surface of the radiating substrate 203 or on the surface of the radiating substrate 203 away from the radiating surface.

Among them, regardless of the bending method, there can be an angle between the first bending section 204 and the radiating substrate 203. It should be noted that the angle is greater than 0 degree. In some examples, the angle can be greater than a preset degree, such as greater than 45 degrees, to ensure that the first bending section 204 can serve as a continuation of the radiating substrate 203 for transmitting signals.

Among them, the radiating substrate 203 serves as the radiating surface of the antenna, and the first bending section 204 can also serve as a radiating surface. In the present disclosure, the radiating surface of the radiating substrate 203 is referred to as the main radiating surface, and the radiating surface of the first bending section 204 is referred to as the sub radiating surface, where the size of the main radiating surface is larger than that of the sub radiating surface. Specifically, the size of the first bending section 204 may be smaller than the size of the radiating substrate 203.

Among them, the size of the first bending section 204 being smaller than the size of the radiating substrate 203 may refer to the size of the orthographic projection of the first bending section 204 on the plane where the radiating surface of the radiating substrate 203 is located, may be smaller than the size of the radiating surface of the radiating substrate 203. Assuming that the size of the orthographic projection of the first bending section 204 on the plane where the radiating surface of the radiating substrate 203 is located can include a first size extending along the first direction and a second size extending along the second direction, as shown in FIG. 2, the first direction can be the x direction, the second direction can be the y direction, and the first direction and the second direction are orthogonal. In one example, the first size of the orthographic projection of the first bending section 204 on the plane where the radiating surface is located in the x direction may be equal to the size of the radiating substrate 203 along the x direction, and the second size of the orthographic projection of the first bending section 204 in the y direction may be smaller than the size of the radiating substrate 203 along the y direction.

In one example, as shown in FIG. 4, the size a2 of the orthographic projection of the first bending section 204 on the plane where the radiating surface (the first plane S1) of the radiating substrate 203 is located in the y direction can be 5 mm, and the size a1 occupied by the two radiating substrates 203 in the y direction can be 39 mm. The size of the orthographic projection of the first bending section 204 on the first plane S1 in the y direction can be 26.5 mm, and the size a3 of the radiating substrate 203 in the y direction can be 26.5 mm.

Among them, by designing the size of the first bending section 204 and the angle between the first bending section 204 and the radiating substrate 203, the performance indicators such as antenna radiation pattern gain and wave width can be adjusted. That is to say, through the first bending section 204, not only can it achieve conformity with the cylindrical shell 100, but it can also adjust the performance indicators such as the antenna radiation pattern gain and the wave width. In some embodiments, the antenna unit 200 may further include a reflective plate 300, the reflective plate 300 is used to reflect the signal radiated to the back surface of the radiating substrate 203. For example, the first bending section 204 may radiate a portion of the signals to the back surface of the radiating substrate 203. At this time, the reflective plate 300 can reflect such signals to reduce the loss of the transmitted signal.

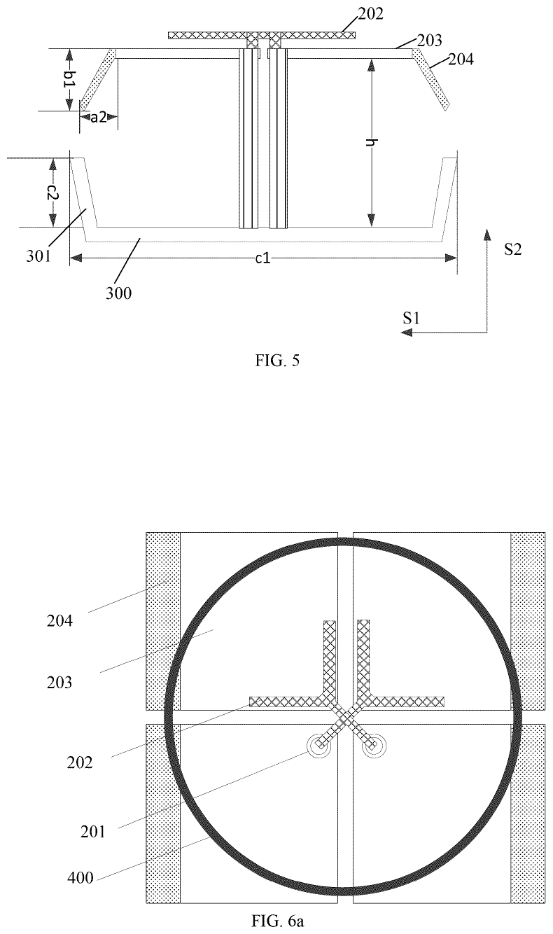

Specifically, as shown in FIG. 5, it shows a top-view plan diagram of another antenna unit according to an embodiment of the present disclosure. The antenna unit includes the reflective plate 300, the reflective plate 300 is connected to an end of the coaxial cable conductor 201 away from the radiating substrate 203.

The reflective plate 300 is provided with a second bending section 301 bent towards the first bending section 204 at an edge close to the side wall that is in the shape of the arc, and the first bending section 204 is bent towards the second bending section 301.

An orthographic projection of the second bending section 301 on a second plane does not overlap with an orthographic projection of the first bending section 204 on the second plane, wherein the second plane is a plane parallel to the coaxial cable conductor 201.

In the present disclosure, at least one bending section of the antenna unit 200, not only includes the first bending section arranged on the radiating substrate 203, but also include the second bending section arranged on the reflective plate 300, so that different components of the antenna unit can conform to the cylindrical shell.

As shown in FIG. 2 and FIG. 5, the reflective plate 300 is connected to one end of the coaxial cable conductor 201 away from the radiating substrate 203. Specifically, there is a spacing distance between the reflective plate 300 and the radiating substrate 203 of the antenna unit 200, which can be greater than or equal to the axial length of the coaxial cable conductor 201. For example, as shown in FIG. 5, the vertical distance between the reflective plate 300 and the radiating substrate 203 can be 30 mm.

In this embodiment, the size of the reflective plate 300 is larger than the size of the area occupied by all the radiating substrates 203 in the antenna unit 200. That is to say, the reflective plate 300 can cover all the radiating substrates 203 in the antenna unit 200, thereby achieving total reflective of the signals.

Among them, in order to achieve conformity with the cylindrical shell 100, the reflective plate 300 has the second bending section 301 at the edge close to the arc-shaped side wall, the second bending section 301 is bent towards the first bending section 204, and the first bending section 204 also is bent towards the second bending section 301. It should be noted that there is also a spacing distance between the first bending section 204 and the second bending section 301 of the reflective plate 300.

Specifically, when viewed from the direction of the second plane, the orthographic projection of the second bending section 301 on the second plane does not overlap with the orthographic projection of the first bending section 204 on the second plane. In other words, there is a spacing distance between the end of the first bending section 204 close to the second bending section 301 and the end of the second bending section 301 close to the first bending section 204.

It should be noted that since the first bending section 204 is oriented towards the second bending section 301, and the second bending section 301 is oriented towards the first bending section 204, there is a spacing distance between the end of the first bending section 204 close to the second bending section 301 and the end of the second bending section 301 close to the first bending section 204, and the spacing distance is smaller than the spacing distance between the radiating substrate 203 and the reflective plate 300.

Among them, the surface of the reflective plate 300 used for reflecting signals is called the reflective surface, and the surface that does not reflect signals is called the reflective back surface, where the reflective surface faces the radiating substrate 203. As described in the above embodiment, if the arc-shaped side wall is the concave side wall towards the inside of the cylindrical shell 100, the first bending section 204 is folded on the back surface facing away from the radiating surface, and the second bending section 301 is folded on the reflective surface of the reflective plate 300. If the arc-shaped side wall is the convex side wall towards the outside of the cylindrical shell 100, the first bending section 204 can be bent away from the radiating surface, and the end of the first bending section 204 away from the radiating substrate 203 is oriented towards the side wall, as shown in FIG. 5. Then, the second bending section 301 can be bent towards the reflective surface, and the end of the second bending section 301 away from the reflective substrate is oriented towards the side wall.

Among them, the sizes of the first bending section 204 and the second bending section 301 may be different. Specifically, the size of the first bending section 204 may be smaller than that of the second bending section 301. In one example, the thickness of the first bending section 204 may be smaller than the thickness of the second bending section 301, and the area of the radiating surface of the first bending section 204 may be smaller than the area of the reflecting surface of the second bending section 301.

Among them, the plane parallel to the coaxial cable conductor 201 can be referred to as the second plane S2, and the plane perpendicular to the coaxial cable conductor 201 can be referred to as the first plane S1, the first plane is the plane where the radiating surface of the radiating substrate 203 is located. It can be seen that the first plane is perpendicular to the second plane, which are two orthogonal planes.

Specifically, as shown in FIG. 5, the size c2 of the orthographic projection of the second bending section 301 on the second plane S2 may be greater than the size b1 of the orthographic projection of the first bending section 204 on the second plane S2. For example, if the size c2 of the orthographic projection of the second bending section 301 on the second plane S2 is 10.3 mm. then the size b1 of the orthographic projection of the first bending section 204 on the second plane S2 may be 6.5 mm.

In another example, the size of the orthographic projection of the second bending section 301 on the first plane S1 may be smaller than the size b2 of the orthographic projection of the first bending section 204 on the first plane S1. For example, if the size of the orthographic projection of the second bending section 301 on the first plane S1 is 4.5 mm, then the size b2 of the orthographic projection of the first bending section 204 on the first plane S1 may be 5 mm.

Among them, in order to improve the reflection effect of the reflective plate 300 on the signal reflected by the radiating plate into the inside of the cylindrical shell, the orthographic projection of the reflective plate 300 on the first plane can fully cover the orthographic projections of the radiating substrates 203 on the first plane. Thus, the second bending section 301 can be located on the outer side of the first bending section 204.

Specifically, the first orthographic projection of the first bending section 204 on the first plane is located at the side of the second orthographic projection, close to the radiating substrate 203, of the second bending section 301 on the first plane. Among them, the first orthographic projection does not overlap or partially overlaps with the second orthographic projection.

Among them, the first orthographic projection and the second orthographic projection may not overlap, or the first orthographic projection and the second orthographic projection may overlap, and the overlap may be partial. Whether overlapping or not, the end of the second bending section 301 can be located outside the end of the first bending section 204, thereby reflecting the signal radiated by the first bending section 204.

In some embodiments, the antenna unit 200 may also include a resonant structure 400 corresponding to a dipole, the resonant structure 400 can be used for increasing the resonant point of the antenna unit 200.

The resonant structure 400 is arranged at a side of the radiating substrate 203 away from the feed structure 202, and an orthographic projection of the resonant structure 400 on the first plane overlaps with the orthographic projection of the radiating substrate 203 on the first plane. Among them, the first plane is parallel to a radiating surface of the radiating substrate 203.

Specifically, the resonant structure 400 can be made of metal material and can be located at the back side of the radiating substrate 203, that is, at the side away from the radiating surface, with a certain spacing distance between the resonant structure 400 and the radiating substrate 203. Specifically, the orthographic projection of the resonant structure 400 on the first plane S1 overlaps with the orthographic projection of the radiating substrate 203 on the first plane S1.

The spacing distance between the resonant structure 400 and the radiating substrate 203 can be determined according to the resonant points that need to be added.

Among them, in the case of including two orthogonal dipoles, the antenna unit includes four radiating substrates 203. In this case, the orthographic projections of the resonant structure 400 on the first plane S1 overlap with the orthographic projections of the four radiating substrates 203 on the first plane S1, respectively.

In one example, the orthographic projection of the resonant structure 400 on the first plane S1 does not overlap with the orthographic projection of the feed structure 202 on the first plane S1, which means that resonant structure 400 can be positioned away from the feed structure 202.

In some examples, the antenna unit may include two orthogonal dipoles, and the resonant structure 400 may include a circular ring 401.

Alternatively, the resonant structure 400 may include a plurality of circular arcs that are spaced, different circular arcs correspond to different radiating substrates 203, and the plurality of circular arcs correspond to a same center point of a circle.

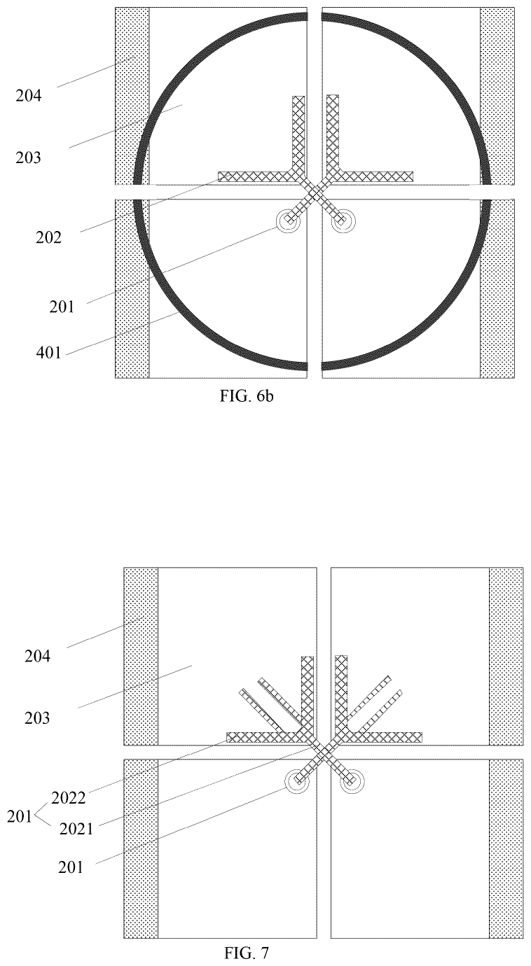

Referring to FIG. 6a and FIG. 6b, FIG. 6a shows a top-view plan diagram of an antenna unit 200 when the resonant structure 400 is the circular ring 401, and FIG. 6b shows a top-view plan diagram of an antenna unit 200 when the resonant structure 400 is the circular arc.

As shown in FIG. 6a, the resonant structure 400 can be the circular ring 401, which can be referred to as a parasitic circular ring 401, used to increase the resonant point of the antenna unit 200. The sizes of the circular ring 401, such as the line width, the radius, and the spacing distance between the circular ring 401 and the radiating substrate 203, can be set according to the resonant points that need to be added.

As shown in FIG. 6b, the resonant structure 400 may include multiple circular arcs, orthographic projections of different circular arcs on the first plane S1 are located within the orthographic projections of the corresponding radiating substrates 203 on the first plane S1. The orthographic projections of the multiple circular arcs on the first plane S1 do not overlap with each other and have a certain spacing distance between them. Similarly, the sizes of each circular arc, such as the line width, the radius, and the spacing distance between the circular arc and the radiating substrate 203, can be set according to the resonant points that need to be added.

In some embodiments, tunable devices can also be installed in the gaps between multiple spaced circular arcs to achieve tuning of the antenna unit 200.

Specifically, the multiple circular arcs need to be set towards the same center point of a circle, to ensure uniform resonance of the entire antenna unit 200.

Below, the structures of the first bending section 204 and the radiating substrates 203 in the antenna unit 200 of the present disclosure will be described in detail.

As shown in FIG. 5, the antenna unit includes two orthogonal dipoles, the first bending section 204 can form a certain angle with the radiating substrate 203, specifically, the angle can be adapted to the curvature of the arc on the cylindrical shell 100. Among them, in the case where the curvature of the arc represents that its side wall is concave into the shell, the angle between the first bending section 204 and the radiating substrate 203 can be an acute angle, that is, greater than the preset angle and less than 90 degrees. Thus, the first bending section 204 can adapt to the arc-shaped side wall and be bent along the concave curvature.

Among them, as shown in FIG. 1, in the case where the curvature of the arc represents that the side wall is convex towards the outside of the shell, the angle between the first bending section 204 and the radiating substrate 203 can be an obtuse angle, that is, greater than 90 degrees. In this case, the first bending section 204 can be bent along the convex curvature.

In some examples of this embodiment, the angle between the first bending section 204 and the radiating substrate 203 may be the obtuse angle, so that the microwave signal can be emitted outward as much as possible at the first bending section 204.

In one example, the angle between different radiating substrates 203 and the corresponding first bending section 204 may be the same, for example, the angle between the radiating substrate 203 of the dipole E and the first bending section 204, and the angle between the radiating substrate 203 of the dipole F and the first bending section 204 are the same, resulting in two orthogonal dipoles presenting a symmetrical first bending section 204.

Certainly, in order to achieve conformity with the cylindrical shell, in some cases, the angle between different radiating substrates 203 and the corresponding first bending section 204 may also be different, and there is no limitation here.

In some embodiments, the coaxial cable conductor 201 of the antenna unit 200 is perpendicular to the radiating substrate 203, that is, the axis directions of the inner conductor 2011 and outer conductor 2012 of the coaxial cable conductor 201 are perpendicular to the radiating surface of the radiating substrate 203, as shown in FIG. 5. The size of the first bending section 204 may be smaller than the size of the radiating substrate 203. Specifically, the size of the orthographic projection of the first bending section 204 on the first plane may be smaller than the size of the orthographic projection of the radiating substrate 203 on the first plane. Among them, the first plane is a plane perpendicular to the coaxial cable conductor 201.

In this embodiment, the area of the radiating surface of the first bending section 204 is smaller than the area of the radiating surface of the radiating substrate 203. In an optional example, both the radiating substrate 203 and the first bending section 204 can be rectangular in shape. The radiating substrate 203 has a length and width, and the first bending section 204 also has a length and width. The length of the radiating substrate 203 can be equal to the length of the first bending section 204 (i.e., the size of the radiating substrate 203 in the x direction is equal to the size of the orthographic projection of the first bending section 204 on the first plane in the x direction), and the width of the radiating substrate 203 can be greater than the width of the first bending section 204 (i.e., the second size of the orthographic projection of the first bending section 204 on the first plane in the y direction is smaller than the size of the radiating substrate 203 in the y direction).

In one embodiment, the shape of the radiating substrate 203 can be quadrilateral, circular, elliptical, fan-shaped, or irregular. The first bending section 204 can be regarded as an extension of the edge of the radiating substrate 203, and its shape can be adapted to the shape of the radiating substrate 203. It should be noted that the shapes of the two radiating substrates 203 of one dipole are symmetrical, and in the case of including two dipoles, the shapes of the four radiating substrates 203 are also symmetrical.

Next, the feed] structure 202 will be explained.

In some embodiments, the feed structure 202 may be a branch-shaped structure, such as including multiple branches. One branch is used to be connected to the inner conductor 2011, while the other branches act as drainage branches, coupling the current fed from the inner conductor 2011 to different directions of the radiating substrate 203. As shown in FIG. 2 and FIG. 4, it is a branch-shaped feed structure 202, which can help improve the uniform transmission of electrical signals fed into the radiating substrate 203.

Specifically, the feed structure 202 may include a first feeder line 2021 and a plurality of second feeder lines 2022; one end of the first feeder line 2021 is connected to the inner conductor 2011, and the other end of the first feeder line 2021 is connected to the plurality of second feeder lines 2022; the plurality of second feeder lines 2022 are coupled to the radiating substrate 203 coupled to the feed structure 202, and the plurality of second feeder lines 2022 extend along different directions of the radiating substrate 203.

Specifically, the plurality of second feeder lines 2022 may not be parallel to each other, as shown in FIG. 4, or the plurality of second feeder lines 2022 may include non-parallel feeder lines or parallel feeder lines, as shown in FIG. 7.

In this embodiment, a branch-shaped feed structure 202 is formed between the first feeder line 2021 and the plurality of second feeder lines 2022. The plurality of second feeder lines 2022 can be understood as multiple branches of the first feeder line 2021, used to feed electrical signals into areas of different directions of the radiating substrate 203.

Among them, the second feeder line 2022 coupled to the radiating substrate 203 in the feed structure 202 can extend along the first direction or the second direction of the radiating substrate 203. The first direction and the second direction are the extension directions of the two adjacent sides of the radiating substrate 203. Based on the shape of the radiating substrate 203, the first direction and the second direction can be orthogonal, or the first direction and the second direction can form other angles.

Specifically, the size of the second feeder line 2022 extending along the first direction in the first direction is smaller than the size of the radiating substrate 203 in the first direction, for example, the size of the second feeder line 2022 extending along the y direction in the y direction is smaller than the size of the radiating substrate 203 in the y direction. The size of the second feeder line 2022 extending along the second direction in the second direction is smaller than the size of the radiating substrate 203 in the second direction, for example, the size of the second feeder line 2022 extending along the x direction in the x direction is smaller than the size of the radiating substrate 203 in the x direction. Among them, impedance matching can be achieved by changing the lengths and line widths of the second feeder line 2022 and the first feeder line 2021. For example, in an antenna unit 200, the length d1 of the second feeder line 2022 may be 12 mm, and the line width d2 may be 2 mm.

Among them, different second feeder lines 2022 may have the same size, for example, different second feeder lines 2022 may have the same length and line width. Alternatively, in another example, different second feeder lines may have different sizes, for example, different second feeder lines 2022 may have the same length and different line widths, or different second feeder lines 2022 may have different lengths and the same line width, or different second feeder lines 2022 may have different lengths and different line widths.

In one example, as shown in FIG. 2 and FIG. 4, the plurality of feeder lines may include two second feeder lines 2022, which extend along two adjacent sides of the coupled radiating substrate 203, thereby achieving feeding from the sides of the radiating substrate 203 to the radiating substrate 203.

In this example, the angle between the two second feeder lines 2022 can be adapted to the angle between two adjacent sides of the radiating substrate 203. If the angle between adjacent sides is a right angle, then the two second feeder lines 2022 are perpendicular to each other. If the angle between adjacent sides is an obtuse angle, then the angle between the two second feeder lines 2022 is also the obtuse angle. If the angle between adjacent sides is an acute angle, then the angle between the two second feeder lines 2022 is also the acute angle.

Specifically, the angle between the two second feeder lines 2022 can be equal to the angle between the two adjacent sides of the radiating substrate 203, so that the current fed through the feed structure 202 can be accurately fed along the edge of the radiating substrate 203, thereby overflowing around the radiating substrate 203.

In one example, it may also include two second feeder lines 2022, which may not be perpendicular to each other and may form other angles, such as the acute angle or the obtuse angle. They can extend along directions of two different non edge paths of the radiating substrate 203, for example, extending in a direction at a certain angle to the side edge of the radiating substrate 203, thereby achieving feeding to the radiating substrate 203.

In another example, it may include three or even more second feeder lines 2022, which can form branches branching in different directions, to feed different areas on the radiating substrate 203, thereby improving the uniformity of feeding to the radiating substrate 203 and enhancing the performance of the antenna unit 200. In this example, among the plurality of second feeder lines 2022, there is an angle between two adjacent second feeder lines 2022. Specifically, the angle between every two adjacent second feeder line 2022 can be the same or different. Under the same angle, the uniformity of feeding is higher. Under different angles, feeding of the feed structure 202 can match the regional characteristics of the radiating substrate 203 to adapt to the shape of the current path of the radiating substrate 203, thereby improving the radiation effect.

Among them, in one example, there are three or even more second feeder lines 2022, and the angle between every two second feeder lines 2022 is less than or equal to 90 degrees.

In this example, in one case, the outermost two second feeder lines 2022 among the plurality of second feeder lines 2022 are perpendicular to each other, and each second feeder line 2022 located between the two perpendicular second feeder lines 2022 has an angle less than 90 degrees with the outermost second feeder line 2022.

In this example, in another scenario, the angle between the outermost two second feeder lines 2022 among the plurality of second feeder lines 2022 may be less than 90 degrees, while each second feeder line 2022 located between the outermost two second feeder lines 2022 has an angle less than 90 degrees with the outermost second feeder line 2022.

In some examples, as described above, in the case of including three or even more second feeder lines 2022, the plurality of second feeder lines 2022 may include feeder lines extending along two adjacent sides of the radiating substrate 203, as well as feeder lines extending along a path between two adjacent sides of the radiating substrate 203. In this way, the feed structure 202 can feed along the edges and inside of the radiating substrate 203, respectively, so that the fed current overflows in various areas of the radiating substrate 203 to enhance its radiation capability.

In the specific design, the plurality of second feeder lines 2022 include a third feeder line extending along two adjacent sides of the radiating substrate 203, and a fourth feeder line located between the two third feeder lines. Among them, the line width of the fourth feeder line is greater than that of the third feeder line. And/or, the length of the fourth feeder line is greater than the length of the third feeder line.

Among them, there may be one or more fourth feeder line. Referring to FIG. 7, it shows a top-view plan diagram of another antenna unit 200 according to an embodiment of the present disclosure, and FIG. 7 illustrates the case of including two fourth feeder lines. In this example, as shown in FIG. 7, among the plurality of second feeder lines 2022, the angle between the outermost two third feeder lines is equal to 90 degrees. The fourth feeder line located between the outermost two third feeder lines can be parallel to each other, as shown in FIG. 7, including four second feeder lines 2022. The outermost two third feeder lines are perpendicular to each other, and the two fourth feeder lines located between the outermost two third feeder lines are parallel to each other.

Certainly, in some other examples, the fourth feeder line located between the outermost two third feeder lines may not be parallel. Specifically, in the case of three or more second feeder lines 2022, there may be various branching forms.

When using this feed structure 202, two third feeder lines can extend along two adjacent sides of the radiating substrate 203, so that the third feeder lines can feed current into the sides of the radiating substrate 203. The fourth feeder line is located between two third feeder lines and can feed current into the middle area of the radiating substrate 203, such as the path along the diagonal, so that current can be fed into both the edge and the inner diagonal of the radiating substrate 203. This can increase the number of feeding paths for current on the radiating substrate 203, thereby improving the uniformity of the fed current on the radiating substrate 203 and ensuring that current is fed into all areas of the radiating substrate 203.

Among them, the line width of the fourth feeder line can be greater than that of the third feeder line, and the line length of the fourth feeder line can be equal to or less than that of the third feeder line. Certainly, in some examples, as shown in FIG. 7, the line width of the fourth feeder line can also be smaller than that of the third feeder line, and the line length of the fourth feeder line can also be greater than that of the third feeder line. Specifically, the design can be based on the actual shape and size of the radiating substrate 203, without any special limitations.

When adopting this design, the coupling degree between the middle area of the radiating substrate 203 and the feed structures 202 can be increased, ensuring that the coupling in the middle area is not significantly different from that in the edge area of the radiating substrate 203, thereby improving the uniformity of feeding and ensuring the performance of the antenna unit 200.

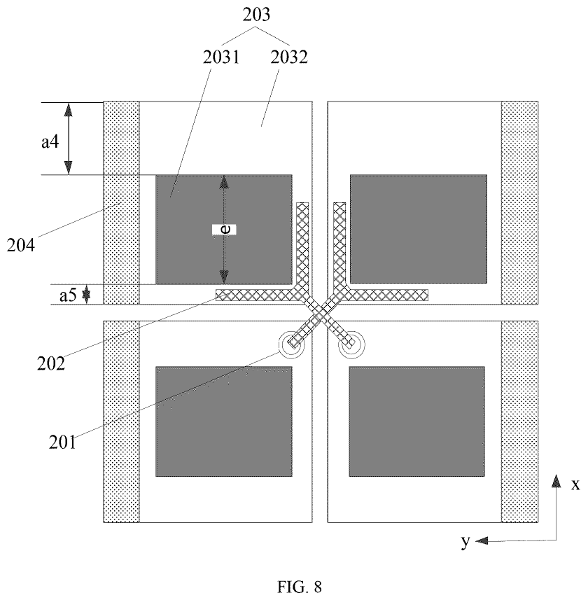

In some embodiments, the radiating substrate 203 can be a fully solid-material substrate or a substrate including a hollow area 2031. Referring to FIG. 8, it shows a top-view plan diagram of another antenna unit. As shown in FIG. 8, each radiating substrate 203 has the hollow area 2031 and a solid material area 2032, the solid material area 2032 is used to couple with the feed structure 202, so that multiple feeder lines on the feed structure 202 can feed to the solid material area 2032 respectively.

Specifically, as shown in FIG. 8, the solid material area 2032 can enclose the hollow area 2031, there may be one or more the hollow area 2031, and in the case of including a plurality of hollow areas 2031, there is a gap between the plurality of hollow areas 2031.

In this example, due to the setting of the hollow area 2031, the radiating substrate 203 is divided into a plurality of current paths. That is to say, different areas of the solid material area 2032 around the hollow area 2031 can form different current paths. As shown in FIG. 8, the hollow area 2031 is rectangular, and the four sides of the solid material area 2032 around the hollow area 2031 form the current paths extending along the four sides of the radiating substrate 203. The hollow area 2031 can be regarded as an insulating area. Therefore, the current fed into the feed structure 202 is limited to flow through the edges of the radiating substrate 203, making the current path in the radiating substrate 203 relatively longer, which can help with the miniaturization design of the radiating substrate 203. At the same time, the radiating substrate 203 has the hollow area 2031, which can reduce the weight of the radiating substrate 203 and facilitate the lightweight design of the antenna unit 200.

In some embodiments, the shape of the hollow area 2031 includes at least one of a polygon, a circle, a sector, an ellipse, and an irregular shape.

Specifically, the hollow area 2031 can be a square, a rectangle, a parallelogram, or an irregular quadrilateral. Alternatively, it can be circular, elliptical, or fan-shaped. Among them, the shape of the hollow area 2031 can belong to the same shape as the shape of the radiating substrate, for example, both belong to the square, the rectangle, or the parallelogram; alternatively, both belong to the circular shape or the fan-shaped shape. Among them, the shape of the hollow area 2031 can be different from the shape of the radiating substrate, such as the radiating substrate being square and the hollow area being rectangular. For example, if the radiating substrate is a quadrilateral, the hollow area can be circular. If the radiating substrate is fan-shaped, the hollow area 2031 can be quadrilateral.

Among them, the area of the hollow area 2031 can be larger than that of the solid material area. In this case, the weight of the radiating substrate can be further reduced, achieving lightweight and miniaturized design of the antenna unit. Among them, the area of the hollow area can also be smaller than the area of the solid material area, and there is no special limitation here.

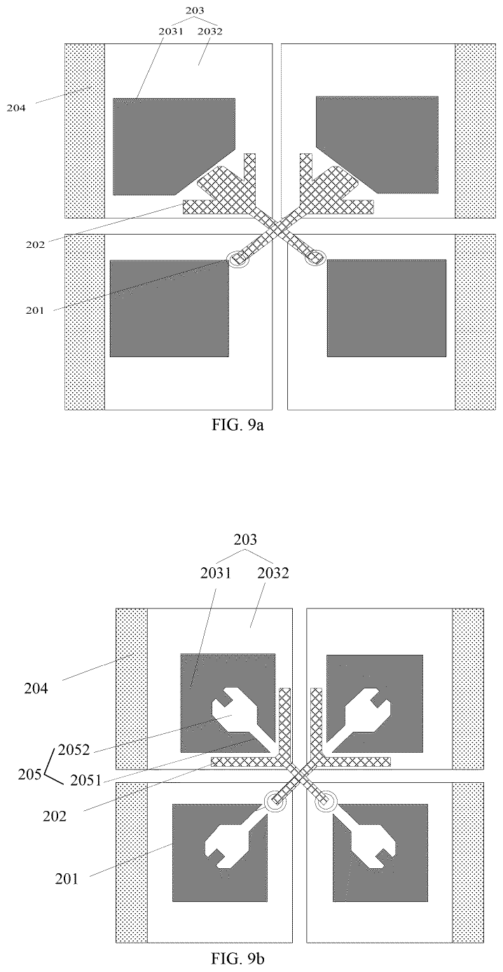

Among them, referring to FIG. 9a, it shows a top-view plan diagram of an antenna substrate. As shown in FIG. 9a, in the same dipole, two radiating substrates 203 can include hollow areas 2031 of the same shape, or hollow areas 2031 of different shapes. Specifically, the shape of the hollow area 2031 of one radiating substrate 203 connected to the inner conductor 2011 can be adapted to the shape of the feed structure 202. Specifically, as shown in FIG. 9a, the feed structure 202 includes one first feeder line 2021 and three second feeder lines 2022. Among the three second feeder lines 2022, there are two orthogonal third feeder lines located on the outermost side. There is a fourth feeder line between the two third feeder lines. The radiating substrate 203 coupled to the second feeder line 2022 in the dipole has a pentagonal hollow area 2031, and the other radiating substrate 203 in the dipole has a rectangular hollow area 2031.

Certainly, FIG. 9a is only an exemplary illustration and does not represent a limitation on the hollow area 2031 of the present disclosure.

In some embodiments, the solid material area 2032 surrounds the hollow area 2031, so that different sides of the solid material area 2032 adjacent to the hollow area 2031 can be regarded as different path areas. In this way, the solid material area 2032 can include a plurality of path areas that are interconnected, which are used to provide current paths. Specifically, the plurality of path areas may include a target path area 205 that extends into the hollow area 2031.

Referring to FIG. 9b, it shows a top-view plan diagram of another antenna unit 200. As shown in FIG. 9b, each radiating substrate 203 has the hollow area 2031 and the solid material area 2032. The hollow area 2031 has an irregular shape, and the solid material area 2032 includes a plurality of path areas. Specifically, the plurality of path areas may include path areas extending along the four edges of the radiating substrate 203, such as four path areas that can be enclosed as a quadrilateral. In the area enclosed by the four path areas, there is also a target path area 205, which extends into the quadrilateral enclosed by the four path areas. From a top view, the target path area 205 extends into the hollow area 2031.

Specifically, in an exemplary embodiment, when the radiating substrate 203 is rectangular as a whole, the target path area 205 can be considered as a path area located on the diagonal of the radiating substrate 203, while the remaining path areas can be located around the radiating substrate 203.

In some examples, as shown in FIG. 9b, the target path area 205 can be shaped like a wrench, with the wrench-shaped handle portion interconnected to the remaining path areas, and the head portion of the wrench extending away from the handle and into the hollow area 2031.

Specifically, the target path area 205 includes a first stub area 2051 and a second stub area 2052 interconnected to the first stub area 2051.

A size of the second stub area 2052 in a target direction is greater than a size of the first stub area 2051 in the target direction, the target direction is a direction perpendicular to a direction of current flowing through the target path area 205.

The first stub area 2051 is located between the feed structure 202 and the second stub area 2052.

In this embodiment, the target path area 205 can be composed of the first stub area 2051 and the second stub area 2052. In one example, the radiating substrate 203 is rectangular, and the first stub area 2051 can be located on the diagonal of the radiating substrate 203. The second stub area 2052 is connected to the end of the first stub area 2051 away from the feed structure 202. Among them, since the size of the second stub area 2052 in the target direction is larger than the size of the first stub area 2051 in the target direction, the width of the current path formed by the second stub area 2052 is larger than the width of the current path formed by the first stub area 2051, thus forming a radiating structure with a larger size at the end where the current flows through.

Among them, the shape of the first stub area 2051 may be different from that of the second stub area 2052, both the first stub area 2051 and the second stub area 2052 can be polygons, and the number of edges included in the first stub area 2051 may be different from the number of edges included in the second stub area 2052. As shown in FIG. 9b, the first stub area 2051 is strip shaped, and the second stub area 2052 can be octagonal. In some other examples, the first stub area 2051 is strip shaped, and the second stub area 2052 can be in the shape of a hexagon, pentagon, or the like.

Alternatively, the first stub area 2051 can be polygonal, and the second stub area 2052 can be circular, elliptical, or an irregular shape with curvature, as long as the size of the second stub area 2052 is slightly larger than that of the first stub area 2051 to serve as the emission point.

In one embodiment, the second stub area 2052 has a notch at one end away from the feed structure 202, as shown in FIG. 9b. When the notch is formed in the second stub area 2052, the overall shape of the second stub area 2052 can be U-shaped. Certainly, in the case where the second stub area 2052 is circular, elliptical, or other polygonal, the second stub area 2052 also has the notch. By setting the notch, it is possible to limit the width of current flow when it reaches the second stub area 2052, making the current more concentrated and thus increasing the signal transmission performance.

When using the radiating substrate 203 in this embodiment, the corresponding feed structure 202 can be adapted to the shape design of the radiating substrate 203. Specifically, the radiating substrate 203 includes the hollow area 2031 and the solid material area 2032, and the solid material area 2032 includes the plurality of path areas, which includes a target path area 205 extending into the hollow area 2031. The feed structure 202 can also include feeder lines corresponding to the target path area 205. Specifically, the feed structure 202 can include the first feeder line 2021 and the plurality of second feeder lines 2022. Among the plurality of second feeder lines 2022, there may be a feeder line coupled to the target path area 205, which can be referred to as the fifth feeder line 2023. Among them, the fifth feeder line 2023 can be the feeder line coupled to a partial area of the target path area 205 away from the hollow area 2031.

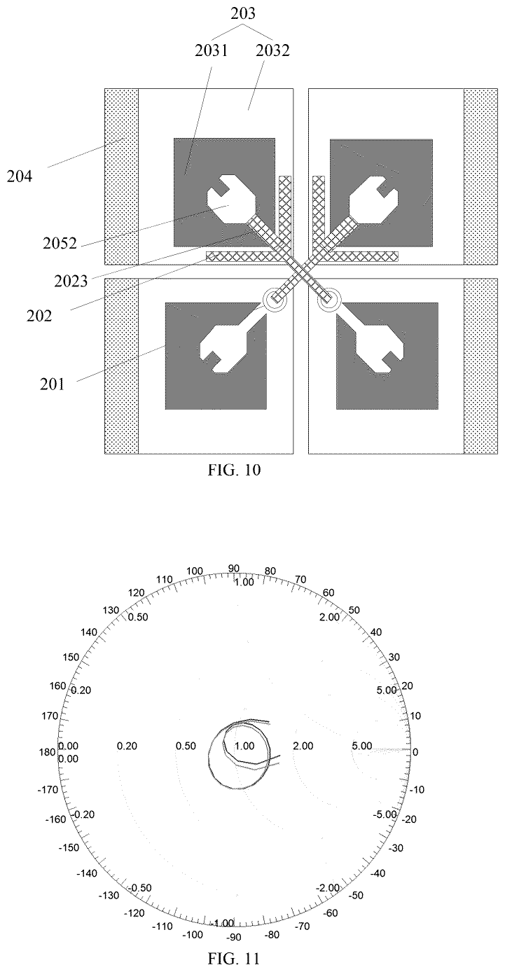

In some examples, referring to FIG. 10, it shows a top-view plan diagram of another antenna substrate 200, the target path area 205 may include the first stub area 2051 and the second stub area 2052, the first stub area 2051 is located between the second stub area 2052 and the feed structure 202, and the fifth feeder line 2023 may be coupled to the first stub area 2051. Specifically, the fifth feeder line 2023 can extend along the length direction of the first stub area 2051 and couple to the first stub area 2051, where the coupling can refer to overlap.

Below, an exemplary design of the antenna unit 200 is presented. The cylindrical shell 100 is a cylindrical shell, with an inner diameter of 60 mm, an outer diameter of 64 mm, and a wall thickness of 2 mm, as shown in FIG. 4, FIG. 5, and FIG. 8. The antenna unit 200 arranged therein includes two orthogonal dipoles, each dipole can include the coaxial cable conductor 201, the feed structure 202, and two radiating substrates 203 located on the same straight line.

Among them, the radiating substrate 203 is rectangular, including the solid material area 2032 and the hollow area 2031 that is also rectangular. The hollow area 2031 is square, and the side length e of the hollow area 2031 is 14 mm. The solid material areas 2032 located on opposite sides of the hollow area 2031 have a size a4 of 8.5 mm in the x direction and a size a5 of 4 mm in the x direction.

Among them, the feed structure 202 includes the first feeder line 2021, one end of the first feeder line 2021 is connected to the inner conductor 2011, and the other end of the first feeder line 2021 is connected to two second feeder lines 2022. The two second feeder lines 2022 are orthogonal and extend along two adjacent solid material areas 2032, respectively. Specifically, the length d1 of the second feeder line 2022 is 12 mm, and the line width d2 of the second feeder line 2022 is 2 mm. The two second feeder lines 2022 have the same length and line width. Among them, impedance matching can be achieved by changing the length and line width of the second feeder line 2022 and the first feeder line 2021.

Among them, the outer conductor 2012 is connected to one of the two radiating substrates 203. When one dipole is excited, the other dipole can act as a ring resonator to broaden the bandwidth of the antenna unit 200.

Among them, each radiating substrate 203 has the first bending section 204 at the edge close to the side wall of the cylindrical shell 100.

Among them, there is also a reflective plate 300, and the vertical distance between the reflective plate 300 and the radiating substrate 203 can be 30 mm. The reflective plate 300 is located inside the cylindrical shell 100, where the size c1 of the orthographic projection of the reflective plate 300 on the first plane S1 is 57 mm, and the size a1 of the orthographic projection of the four radiating substrates 203 on the first plane S1 is 39 mm.

Among them, the reflective plate 300 has the second bending section 301 at the edge close to the side wall of the cylindrical shell 100. The size c2 of the orthographic projection of the second bending section 301 in the second plane S2 is 10.3 mm, and the size b1 of the orthographic projection of the first bending section 204 in the second plane S2 can be 6.5 mm. The size of the orthographic projection of the second bending section 301 in the first plane S1 is 4.5 mm, and the size b2 of the orthographic projection of the first bending section 204 in the first plane S1 can be 5 mm.

Among them, the first bending section 204 does not interfere with the cylindrical shell, achieving good conformal design. Compared with traditional planar cross dipole antennas, this conformal antenna can achieve lower frequency radiation inside the cylinder within the same diameter, providing great help for the miniaturization of the overall structure.

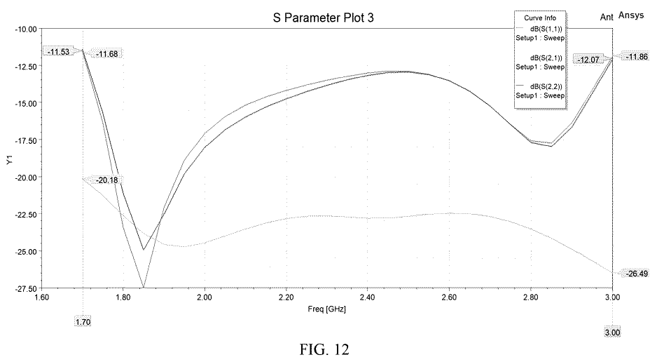

Performance tests are conducted on the exemplary antenna unit 200, as shown in FIG. 11 and FIG. 12. FIG. 11 shows the Smith chart used to express the S-parameters of the wire unit, while FIG. 12 shows the waveform diagram of the S-parameters of the wire unit. It can be seen that in the frequency range of 1.7 GHz-3 GHz, the electrical performance parameters S11 and S22<−11.5 dB, S21<−20 dB, and the relative bandwidth reaches 55.32%.

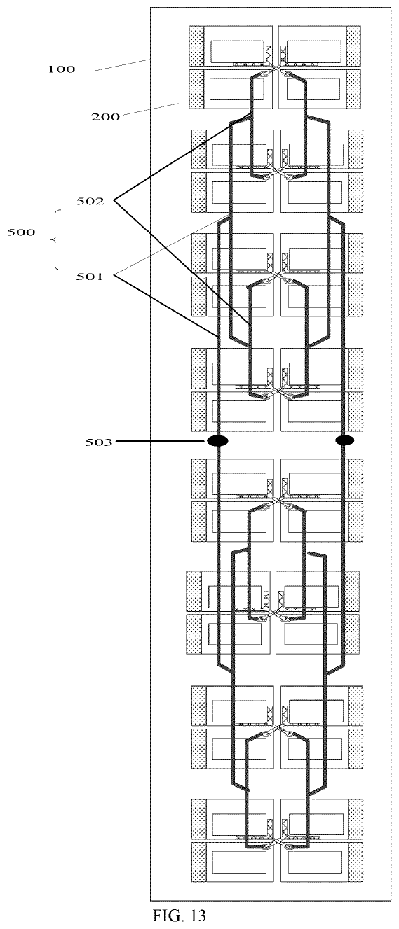

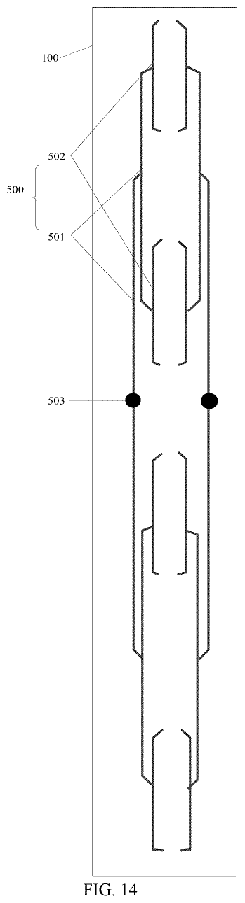

Based on the same inventive concept, the present disclosure also provides an antenna device, as shown in FIG. 13 and FIG. 14. FIG. 13 shows a schematic diagram of a cross-sectional structure of the antenna device in the axial direction of the cylindrical shell 100, and FIG. 14 shows a schematic diagram of the feed network 500. As shown in FIG. 13, the antenna device includes the cylindrical shell 100 and the plurality of antenna units 200, the plurality of antenna units 200 are spaced apart inside the cylindrical shell 100. The antenna device may also include the feed network 500, the feed network 500 is connected to the coaxial cable conductor 201 of each antenna unit 200 to feed electrical signals into the coaxial cable conductor 201 and feed them into the feed structure 202 through the coaxial cable conductor 201.

Among them, the feed network 500 can be sequentially connected to the coaxial cable conductor 201 of each antenna unit 200. Specifically, it can be connected to the inner conductor 2011 and the outer conductor 2012 of the coaxial cable conductor 201 respectively. That is to say, one end of the inner conductor 2011 is connected to the feed network 500, the other end is connected to the feed structure 202, one end of the outer conductor 2012 is connected to the feed network 500, and the other end is connected to the radiating substrate 203.

Among them, as shown in FIG. 13 and FIG. 14, the feed network 500 may include a plurality of first connecting lines 501 and a second connecting line 502 connected to the first connecting line 501. The first connecting line 501 is used to connect the plurality of second connecting lines 502 in series, and each second connecting line 502 is used to feed the two adjacent antenna units 200. As shown in FIG. 13, the two adjacent antenna units 200 are grouped together, and one end of the second connecting line 502 is connected to one antenna unit 200, and the other end is connected to another antenna unit 200. The first connecting line 501 provides electrical signals to each second connecting line 502. Among them, the feed network finally converges into two total feed ports 503 for connecting radio frequency cables.

It should be noted that the cylindrical shell 100 in this embodiment can be a cylindrical, elliptical cylindrical shell 100, or other shell with arc-shaped side walls.

Among them, the plurality of antenna units 200 can be arranged in an array inside the cylindrical shell 100, as shown in FIG. 13. They can be arranged in a row along the axial direction of the cylindrical shell 100, or in n rows and m columns inside the cylindrical shell 100, for example, arranged in m columns in the axial direction of the cylindrical shell 100 and in n rows in the radial direction.

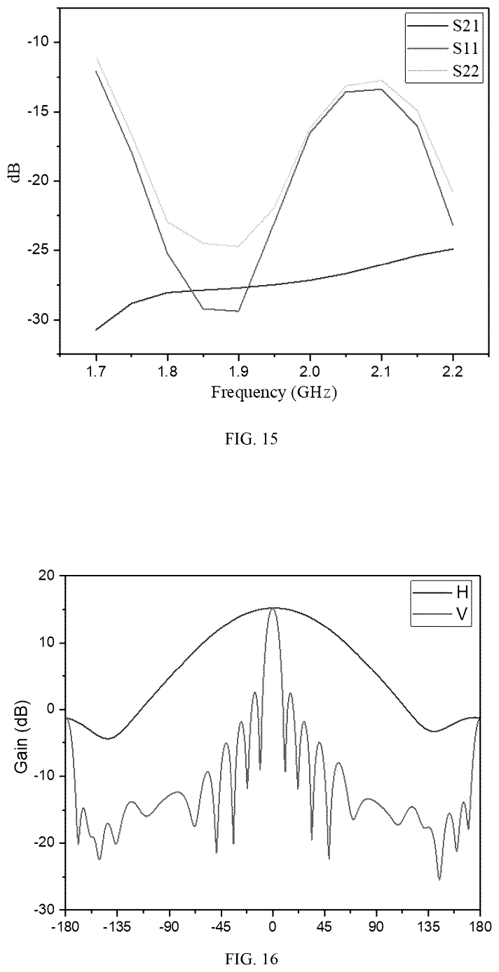

As shown in FIG. 13, in one example, the cylindrical shell 100 can be cylindrical, with a column of antenna units 200 arranged in the axial direction of the cylindrical shell, totaling 8 antenna units 200. The spacing distances between the 8 antenna units 200 inside the cylindrical shell 100 are equal, which can all be 100 mm. When using the antenna device with this setting. referring to FIG. 15 and FIG. 16. FIG. 15 shows the S-parameter diagram when arranging 8 antenna units in an array inside the cylindrical shell, and FIG. 16 shows the directional diagram when arranging 8 antenna units in an array inside the cylindrical shell, in the frequency band of 1.7 GHz-2.2 GHz, S11 and S22<−11 dB, and S21<−24.9 dB.

Based on the same inventive concept, the present disclosure also provides a communication base station including the antenna unit described above, or including the antenna device described above.

The various embodiments in this specification are described in a progressive manner, with each embodiment emphasizing its differences from other embodiments. The same and similar parts between the various embodiments can be referred to each other.

Finally, it should be noted that in this specification, relational terms such as first and second are only used to distinguish one entity or operation from another, and do not necessarily require or imply any actual relationship or order between these entities or operations. Moreover, the terms “comprising/including”, “containing”, or any other variation thereof are intended to encompass non-exclusive inclusion, such that a process, method, good, or equipment that includes a series of elements includes not only those elements, but also other elements not explicitly listed, or elements inherent to such process, method, good, or equipment. Without further limitations, the element defined by the statement “including one . . . ” does not exclude the existence of other identical elements in the process, method, product, or device that includes the element in question.

The above provides a detailed introduction to an antenna unit, an antenna device, and a communication base station provided in the present disclosure. Specific examples are applied in this specification to explain the principles and implementation methods of the present disclosure. The above embodiments are only used to help understand the methods and core ideas of the present disclosure. Meanwhile, for those skilled in the art, there may be changes in the specific implementation methods and application scope based on the ideas of the present disclosure. In summary, the content of this manual should not be understood as limiting the present disclosure.

After considering the specification and practicing the invention disclosed herein, persons skilled in the art will easily come up with other implementation schemes disclosed herein. The present disclosure is intended to cover any variations, uses, or adaptive changes of the present disclosure that follow the general principles of the present disclosure and include common knowledge or customary technical means in the art that are not disclosed in the present disclosure. The specification and embodiments are only considered exemplary, and the true scope and spirit of the present disclosure are indicated by the following claims.

It should be understood that the present disclosure is not limited to the precise structure described above and shown in the accompanying drawings, and various modifications and changes can be made without departing from its scope. The scope of the present disclosure is limited only by the appended claims.

The term “one embodiment”, “embodiment” or “one or more embodiments” referred to in this specification means that specific features, structures or characteristics described in conjunction with the embodiments are included in at least one embodiment disclosed herein. Furthermore, please note that the word “in one embodiment” may not necessarily refer to the same embodiment.

In the manual provided here, a large number of specific details are explained. However, it can be understood that the disclosed embodiments can be practiced without these specific details. In some examples, well-known methods, structures, and techniques are not shown in detail to avoid blurring the understanding of this specification.

In the claims, any reference symbols located between parentheses should not be constructed as limitations on the claims. The word “comprising” does not exclude the existence of elements or steps that are not listed in the claims. The word “a/an” or “one” before the component does not exclude the existence of multiple such components. The present disclosure can be implemented by means of hardware including several different components and by means of appropriately programmed computers. In the unit claims listing several devices, several of these devices may be specifically embodied through the same hardware item. The use of words such as first, second, and third does not indicate any order. These words can be interpreted as names.

Finally, it should be noted that the above embodiments are only used to illustrate the disclosed technical solution and not to limit it. Although the present disclosure has been described in detail with reference to the aforementioned embodiments, those skilled in the art should understand that they can still modify the technical solutions described in the aforementioned embodiments, or equivalently replace some of the technical features. And these modifications or substitutions do not depart from the essence and scope of the corresponding technical solutions disclosed in the present disclosure.

1. An antenna unit, wherein the antenna unit is used for being arranged in a cylindrical shell, at least one side wall of the cylindrical shell is in a shape of an are; and the antenna unit comprises: a coaxial cable conductor, a feed structure and two radiating substrates;
the coaxial cable conductor comprises an inner conductor and an outer conductor sleeved outside the inner conductor, the inner conductor is connected to an end of the feed structure, another end of the feed structure is coupled to one of the two radiating substrates, and the other one of the two radiating substrates is connected to the outer conductor; and
the antenna unit is provided with at least one bending section, to conform to the cylindrical shell through the at least one bending section.

2. The antenna unit according to claim 1, wherein at least one of the two radiating substrates is provided with a first bending section at an edge close to the side wall that is in the shape of the arc, the first bending section has an angle with a plane of the radiating substrates, and the angle is adapted to curvature of the arc.

3. The antenna unit according to claim 2, wherein the angle is an obtuse angle.

4. The antenna unit according to claim 1, wherein the coaxial cable conductor is perpendicular to a radiating surface of the radiating substrate, and a size of an orthographic projection of the first bending section on a first plane is less than a size of an orthographic projection of the radiating substrate on the first plane;
wherein the first plane is a plane perpendicular to the coaxial cable conductor.

5. The antenna unit according to claim 1, wherein the feed structure comprises a first feeder line and a plurality of second feeder lines;
one end of the first feeder line is connected to the inner conductor, and the other end of the first feeder line is connected to the plurality of second feeder lines;
wherein the plurality of second feeder lines are coupled to the radiating substrate coupled to the feed structure, and the plurality of second feeder lines extend along different directions of the radiating substrate.

6. The antenna unit according to claim 5, wherein an angle of every two second feeder lines is less than or equal to 90 degrees.

7. The antenna unit according to claim 5, wherein the plurality of second feeder lines comprise feeder lines extending along two adjacent sides of the radiating substrate.

8. The antenna unit according to claim 5, wherein the plurality of second feeder lines comprise two third feeder lines extending along two adjacent sides of the radiating substrate and a fourth feeder line between the two third feeder lines;
wherein a line width of the fourth feeder line is greater than a line width of the third feeder line; and/or, a length of the fourth feeder line is greater than a length of the third feeder line.

9. The antenna unit according to claim 1, wherein each of the two radiating substrates comprises a hollow area and a solid material area surrounding the hollow area;
wherein the feed structure is coupled to the solid material area.

10. The antenna unit according to claim 9, wherein a shape of the hollow area comprises at least one of a polygon, a circle, a sector, an ellipse, and an irregular shape.

11. The antenna unit according to claim 9, wherein the solid material area comprises a plurality of path areas that are interconnected, and the plurality of path areas form a current path through which current passes;
wherein the plurality of path areas comprise at least a target path area extending into the hollow area.

12. The antenna unit according to claim 11, wherein the target path area comprises a first stub area and a second stub area interconnected to the first stub area;
a size of the second stub area in a target direction is greater than a size of the first stub area in the target direction, the target direction is a direction perpendicular to a direction of current flowing through the target path area;
wherein the first stub area is located between the feed structure and the second stub area.

13. The antenna unit according to claim 12, wherein the second stub area is provided with a notch at an end away from the feed structure.

14. The antenna unit according to claim 11, wherein the feed structure comprises a feeder line coupled to a partial area of the target path area away from the hollow area.

15. The antenna unit according to claim 2, wherein the antenna unit further comprises a reflective plate, the reflective plate is connected to an end of the coaxial cable conductor away from the radiating substrate;
the reflective plate is provided with a second bending section at an edge close to the side wall that is in the shape of the arc, the first bending section is oriented towards the second bending section, and the second bending section is oriented towards the first bending section; and
an orthographic projection of the second bending section on a second plane does not overlap with an orthographic projection of the first bending section on the second plane, wherein the second plane is a plane parallel to the coaxial cable conductor.

16. The antenna unit according to claim 15, wherein an orthographic projection of the reflective plate on a first plane covers orthographic projections of the two radiating substrates on the first plane; the first plane is perpendicular to the second plane;
a first orthographic projection of the first bending section on the first plane is located at a side of a second orthographic projection of the second bending section on the first plane that is close to the radiating substrates;
wherein the first orthographic projection does not overlap with or partially overlaps with the second orthographic projection.

17. The antenna unit according to claim 1, wherein the antenna unit further comprises a resonant structure corresponding to a dipole, the resonant structure is used for increasing a resonance point of the antenna unit;
the resonant structure is arranged at a side of the radiating substrate away from the feed structure, and is spaced apart from the radiating substrate;
an orthographic projection of the resonant structure on a first plane overlaps with an orthographic projection of the radiating substrate on the first plane; wherein the first plane is parallel to a radiating surface of the radiating substrate.

18. The antenna unit according to claim 1, wherein when the antenna unit comprises two orthogonal dipoles, the resonant structure comprises a circular ring;
or, the resonant structure comprises a plurality of circular arcs that are spaced, different circular arcs correspond to different radiating substrates, and the plurality of circular arcs correspond to a same center point of a circle.

19. An antenna device, comprising the cylindrical shell and the plurality of antenna units according to claim 1, wherein the plurality of antenna units are arranged at intervals in the cylindrical shell, and the antenna device further comprises:
a feed network, connected to the coaxial cable conductor of each of the plurality of antenna units, to feed electrical signals into the coaxial cable conductor and feed the electrical signals into the feed structure through the coaxial cable conductor.

20. A communication base station, comprising the antenna unit according to claim 1.
